(19) United States
(12) Patent Application Publication
(10) Pub. No.: US 2023/0146720 A1
(43) Pub. Date: May 11, 2023

(54) VEHICLE DRIVE UNIT AND VEHICLE WITH A VEHICLE DRIVE UNIT

(71) Applicant: Schaeffler Technologies AG & Co. KG, Herzogenaurach (DE)

(72) Inventors: Philipp KAUTZMANN, Karlsruhe (DE); Alexander SEIFFER, Karlsruhe (DE); Dominik NEES, Karlsruhe (DE); Bernhard ZEIFANG, Karlsruhe (DE); Jin LI, Walzbachtal (DE)

(73) Assignee: Schaeffler Technologies AG & Co. KG, Herzogenaurach (DE)

(21) Appl. No.: 17/912,085

(22) PCT Filed: Feb. 24, 2021
(86) PCT No.: PCT/DE2021/100182

§ 371 Date: Sep. 16, 2022

(30) Foreign Application Priority Data
Mar. 24, 2020 (DE) 10 2020 108 095.6

(51) Int. Cl. B60K 7/00; B62D 11/04; B62D 3/06

(52) U.S. Cl. CPC B60K 7/0007; B62D 11/04; B62D 3/06

(57) ABSTRACT

A vehicle drive unit for a vehicle for omnidirectional driving of the vehicle. The vehicle drive unit includes a vehicle platform, a drive platform, and at least two wheels arranged on the drive platform, one drive unit being provided per wheel to drive the wheel. A controllable self-locking steering actuator is arranged between the drive platform and the vehicle platform. The steering actuator is rotatable about a longitudinal axis and is used to rotate the vehicle platform and the drive platform relative to one another, the steering actuator allowing a temporary blocking of the rotation. At least three pivoting wheels are arranged on the vehicle platform for vehicle stabilisation, each being rotatable about its own wheel axis and about its own vertical axis. A vehicle having a vehicle drive unit is also provide.

### CROSS-REFERENCE TO RELATED APPLICATIONS

This application is the U.S. National Phase of PCT Appln. No. PCT/DE2021/100182, filed Feb. 24, 2021, which claims the benefit of German Pa-tent Appln. No. 10 2020 108 095.6, filed Mar. 24, 2020, the entire disclosures of which are incorporated by reference herein.

### TECHNICAL FIELD

The present disclosure initially relates to a vehicle drive unit for a vehicle, which is omnidirectional and can therefore be controlled in any direction within a plane of travel. The vehicle can be, for example, an automated ground vehicle. Furthermore, the disclosure relates to a vehicle having such a vehicle drive unit.

### BACKGROUND

EP 2 744 741 B1 describes a mobile part, which can be an automobile or a forklift. The mobile part comprises an electronic unit and a receiving unit, which is designed as a receiving plate. The electronics unit has an electric drive and drive rollers. Furthermore, the electronics unit is rotatably mounted and has auxiliary rollers. The receiving unit has castors by which the receiving unit is supported and/or movable.

U.S. Pat. No. 9,823,659 B2 shows a motor system comprising a steering motor with a first rotor, which is positioned in a first stator. The steering motor is configured to rotate the first rotor about a steering axis. The motor system also comprises a traction motor having a second stator positioned in a second rotor. The second rotor has a traction surface that defines a wheel. The traction motor is configured to rotate the second rotor about a roll axis. The traction motor is positioned in an opening in the first rotor. The motor system also comprises an axis positioned coaxially with the second rotor and coupled to the first rotor such that the traction motor rotates about the steering axis while the steering motor rotates with the first rotor about the steering axis.

A drive system base or drive platform is known from U.S. Pat. No. 6,491,127 B1, which can be used for a mobile robot, for example. The drive system base has a plurality of castors. Each wheel comprises its own first motor for independent driving and its own second motor for independent steering. Each wheel is rotatably and pivotably mounted in a separate wheel module, which contains both the drive motor and the steering motor. All wheel modules on the drive platform have the same design and are interchangeable. Each wheel module contains a suspension that allows the wheel to move vertically and independently of the base.

A disadvantage of the drives mentioned above is that both a drive motor and an independent steering motor are required for omnidirectional maneuverability of each wheel, which leads to a large number of motors in the vehicle and thus to high costs.

### SUMMARY

Proceeding from the prior art, the object of the present disclosure is to provide an improved vehicle drive unit for a vehicle which enables drive in any direction, requires only a few motors and preferably allows a reduction in the number of sensors required.

Said object is achieved by a vehicle drive unit having one or more of the features disclosed herein and by a vehicle having such a vehicle drive unit.

The vehicle drive unit according to the disclosure for a vehicle forms a component of a vehicle and has functions of a chassis and a drive. The vehicle drive unit allows omnidirectional driving of the vehicle. The vehicle drive unit comprises a vehicle platform and a drive platform, which are preferably arranged coaxially with respect to one another, in relation to an axis that is perpendicular to the driving plane. At least two wheels are arranged on the drive platform, which are used to drive the unit. For this purpose, the vehicle drive unit has a drive unit for driving these wheels for each wheel of the drive platform. The vehicle drive unit also comprises a controllable, self-locking steering actuator. The steering actuator is arranged operatively, i.e. in relation to the generated steering force, between the drive platform and the vehicle platform and preferably rotatable about a longitudinal axis. When the steering actuator is activated, the vehicle platform rotates relative to the drive platform or the drive platform rotates relative to the vehicle platform. The two platforms are rotated relative to one another by an angle by means of the steering actuator, wherein it is possible to define the direction of travel of the vehicle drive unit and the orientation of the vehicle platform via this angle. If the direction of travel of the vehicle drive unit is to be changed, but the orientation of the vehicle platform is to be retained, then the angle between the vehicle platform and the drive platform is changed. The direction of travel corresponds to the orientation of the drive platform. The orientation of the drive platform can be defined via the wheels and/or the steering actuator. If the drive platform is oriented by a predetermined angle in a first direction by means of a defined different speed of the wheels, the steering actuator rotates the vehicle platform in the opposite direction by the same angle so that the vehicle platform maintains its orientation. Alternatively, the steering actuator can rotate the drive platform relative to the vehicle platform, wherein the vehicle platform maintains its orientation. Omnidirectional driving is thus advantageously possible. The steering actuator is also designed in such a way that in a blocked state it allows temporary blocking of the rotational movement between the vehicle platform and the drive platform. When the steering actuator is blocked or deactivated, the angle between the vehicle platform and the drive platform is kept constant. Here, a change in the direction of travel is generated via a different speed of the wheels, wherein the two platforms have a constant orientation when the steering actuator is blocked. The entire vehicle drive unit thus performs a rotational movement when the steering actuator is blocked. The vehicle drive unit further comprises at least three pivoting wheels arranged on the vehicle platform for vehicle stabilization, wherein the at least three pivoting wheels are each rotatable about their own wheel axis and pivotable about their own vertical axis.

Advantageously, the structure of the vehicle drive unit according to the disclosure enables omnidirectional driving, wherein fewer actuators/motors are required than in known omnidirectionally movable vehicles. Omnidirectional driving generally has the advantage that vehicles are more maneuverable, which is particularly positive in tight spaces. Further advantages are that fewer actuators result in a cost reduction and that the system has a simplified structure.

The steering actuator is preferably arranged orthogonally on the drive platform. The steering actuator preferably comprises a rotary block in the form of a brake or a clutch, which can prevent a rotational movement in the blocked state.

The steering actuator particularly preferably comprises a screw drive. The screw drive can be, for example, a ball screw drive with a ball screw spindle, a planetary screw drive, a planetary roller screw drive, a roller screw drive or a worm gear consisting of a worm shaft and a gear train.

The steering actuator also comprises a motor for controlling the steering actuator. A steering actuator consisting of a DC motor and a planetary roller screw drive or a ball screw drive is particularly preferred. Further sensors are preferably provided for the control of the motor, for example to control the speed and torque.

The at least two wheels of the drive platform preferably have a common wheel axis. The steering actuator is oriented perpendicular to the wheel axis. The wheels can be pivoted along the wheel axis about the longitudinal axis of the steering actuator.

Preferably, the drive units of the wheels have a differential drive, i.e., the wheels can be driven independently of one another. The drive units of the wheels are preferably motors.

According to one embodiment, four towed, i.e. non-driven, pivoting wheels are attached to the vehicle platform. Alternatively, more or fewer pivoting wheels can be used. In a further modified embodiment, additional towed pivoting wheels can be attached to the drive platform. In this case, the towed pivoting wheels are only designed as anti-tippers, so they normally do not touch the ground.

In one embodiment, the drive platform is disk-like and the vehicle platform has a central recess for receiving the drive platform, such that both platforms are arranged coaxially. The two platforms are preferably in one plane. The two platforms are particularly preferably arranged coaxially in a common horizontal plane. In an alternative embodiment, the two platforms are arranged one above the other. In this embodiment, the vehicle platform preferably has no recess.

There is a connection between the two platforms. For example, the connection can be made by a rod fastened on the vehicle platform or by a pin in the form of a gear wheel, which is guided through a through-hole in the drive platform. Other types of connection are conceivable.

Power electronics, for example sensors, can be arranged on the drive platform. It is also possible to attach energy storage devices to the drive platform.

For example, a passenger cabin or a transport container can be arranged on the vehicle drive unit.

The vehicle according to the disclosure has the vehicle drive unit described above, with all of the embodiments being usable in various combinations. The vehicle with the vehicle drive unit is, for example, an AGV (automated ground vehicle).

It is understandable that numerous other sensors can be present on the vehicle or on the vehicle drive unit, in particular for realizing safe driving operation. For example, speed and/or torque sensors are preferably provided in order to control the drive unit. The vehicle is designed using conventional means so that the drive wheels always have adequate traction.

### BRIEF DESCRIPTION OF THE DRAWINGS

Additional advantages, details, and further developments of the present disclosure arise from the following description of a preferred embodiment, with reference to the drawings. In the figures:

FIG. 1 shows a plan view of a preferred embodiment of a vehicle drive unit according to the disclosure in a first operating state;

FIG. 2 shows the vehicle drive unit shown in FIG. 1 in a second operating state;

FIG. 3 shows the vehicle drive unit shown in FIG. 1 in a third operating state; and

FIG. 4 shows the vehicle drive unit shown in FIG. 1 in a fourth operating state.

### DETAILED DESCRIPTION

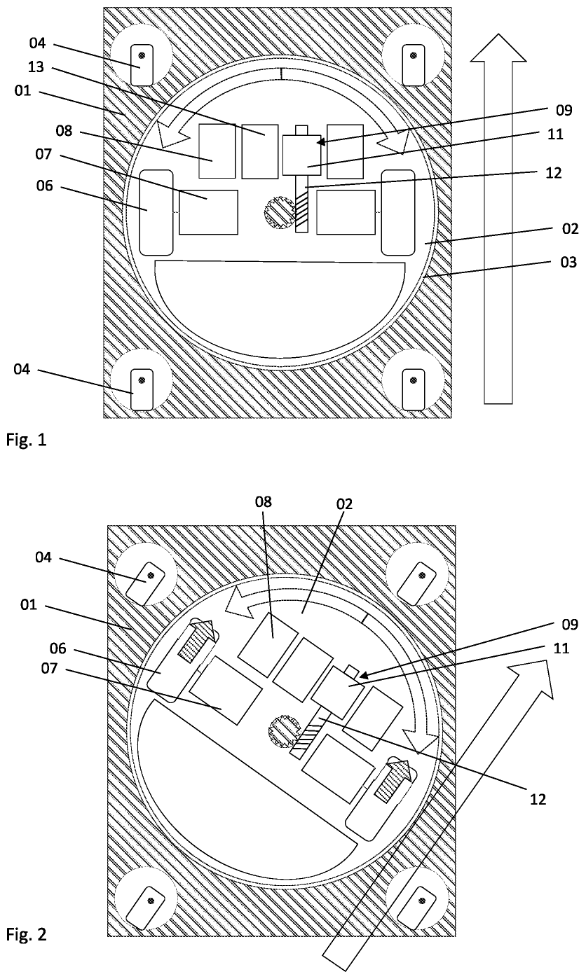

FIG. 1 shows a plan view of a preferred embodiment of a vehicle drive unit according to the disclosure in a first operating state. The vehicle drive unit can be installed in vehicles. The vehicle can drive omnidirectionally by means of the vehicle drive unit according to the disclosure. The vehicle drive unit comprises a vehicle platform 01 and a drive platform 02. The drive platform 02 is disk-like and the vehicle platform 01 is rectangular with a central circular recess 03 in which the drive platform 02 is arranged. In modified embodiments, the shape and arrangement of the drive platform and the vehicle platform can naturally be chosen differently. The two platforms 01, 02 are coaxial with respect to one another. Towed pivoting wheels 04 are arranged on the vehicle platform 01 in the corner regions. The vehicle platform 01 has four pivoting wheels 04, each of which can be rotated about its own wheel axis and pivoted about its own vertical pivot axis. Two differentially driven wheels 06, which have a common horizontal axis of rotation, are arranged on the drive platform 02. Drives or motors 07 for driving the wheels 06 are connected to the two wheels 06, wherein the two drives 07 are arranged on the drive platform 02 and can be controlled independently of one another. The drives 07 can also comprise a transmission and/or a clutch system.

Power electronics 08 are also attached to the drive platform 02. A steering actuator 09 is also attached to the drive platform 02. The steering actuator 09 is designed to be controllable and self-locking. The steering actuator 09 is rotatable about a longitudinal axis and is used to rotate the vehicle platform 01 and the drive platform 02 relative to one another and to temporarily block said rotation if this is desired for the driving situation. The steering actuator 09 comprises a DC motor 11 and a screw drive 12 in the form of a planetary roller screw drive or a ball screw drive. Furthermore, a control unit 13 is provided, which takes over the control of the individual elements. The operating principle of the steering actuator 09 is described below.

The operating state shown in FIG. 1 is when the vehicle drive unit is driving straight ahead, as symbolized by a direction-of-travel arrow. A longitudinal axis of the vehicle platform 01 and a longitudinal axis of the drive platform 02 lie one above the other. The axes of rotation of the wheels 06 and of the pivoting wheels 04 run parallel to one another and transverse to the direction of travel.

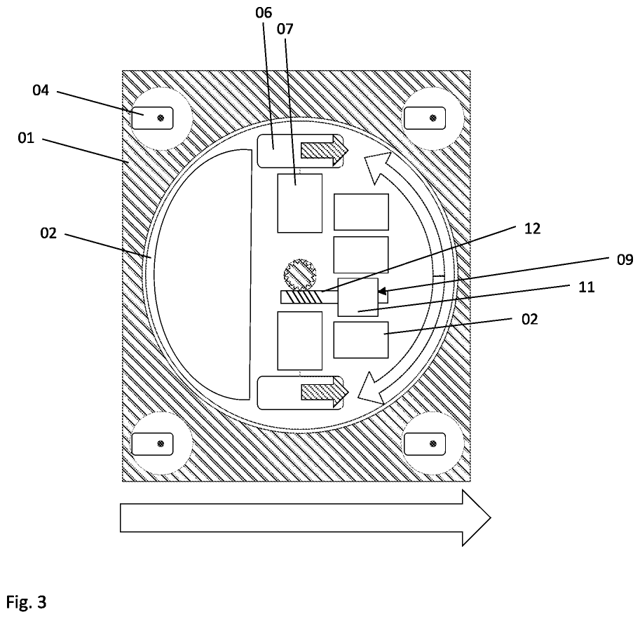

FIG. 2 shows the vehicle drive unit shown in FIG. 1 in a second operating state, in which the vehicle drive unit has been steered in an oblique direction of travel, approximately 45° relative to the straight-ahead driving shown in FIG. 1. In order to assume an oblique direction of travel, the drive platform 02 is rotated in the desired direction by means of the steering actuator 09. The position or orientation of the vehicle platform 01 remains unchanged, so it does not rotate. A defined angle is spanned between the longitudinal axis of the vehicle platform 01 and the longitudinal axis of the drive platform 02—here, for example, approximately 45°. When driving in the oblique direction of travel, the wheels 06 rotate at the same speed and the pivoting wheels 04 follow the movement in the oblique direction in their orientation. It is also conceivable that the wheels 06 cause the drive platform 02 to rotate and the steering actuator 09 counteracts this rotational movement to the same extent on the vehicle platform 01, such that the vehicle platform 01 retains its original orientation.

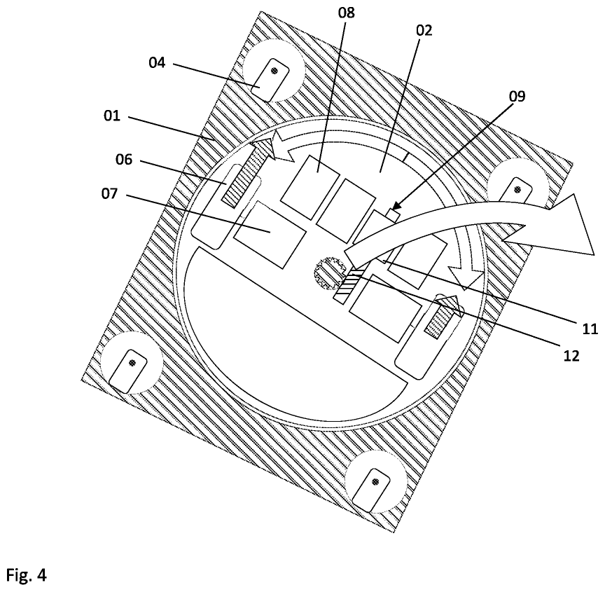

FIG. 3 shows the vehicle drive unit shown in FIG. 1 in a third operating state, in which the vehicle drive unit has been steered in a transverse direction of travel, approximately 90° relative to the straight-ahead driving shown in FIG. 1. In order to assume a transverse direction of travel, the drive platform 02 is rotated in the transverse direction by means of the steering actuator 09. The position or orientation of the vehicle platform 01 remains unchanged, so it does not rotate. An angle of 90° is spanned between the longitudinal axis of the vehicle platform 01 and the longitudinal axis of the drive platform 02. When driving in the transverse direction of travel, the wheels 06 rotate at the same speed and the pivoting wheels 04 follow the movement in the transverse direction with respect to their orientation. It is also conceivable that the wheels 06 cause the drive platform 02 to rotate and the steering actuator 09 counteracts this rotational movement about 90° on the vehicle platform 01, such that the vehicle platform 01 retains its original orientation.

FIG. 4 shows the vehicle drive unit shown in FIG. 1 in a fourth operating state, in which the vehicle drive unit performs a rotating movement relative to the straight-ahead driving shown in FIG. 1. The wheels 06 rotate at different speeds, such that a rotational movement of the drive platform 02 is initiated. The steering actuator 09 is deactivated or blocked so that it is prevented from rotating. By blocking the steering actuator 09, the rotating movement of the drive platform 02 is transferred to the vehicle platform 01, as a result of which the entire vehicle drive unit carries out the rotating movement. No angle is spanned between the longitudinal axis of the vehicle platform 01 and the longitudinal axis of the drive platform 02; the longitudinal axes lie one above the other. The pivoting wheels 04 rotate with the rotational movement and follow the movement.

According to the operating states shown in FIGS. 1 to 4, it can be seen that the vehicle drive unit according to the disclosure can advantageously be driven omnidirectionally, wherein fewer actuators are required than in known vehicle drive units.

### LIST OF REFERENCE SIGNS

01 Vehicle platform
02 Drive platform
03 Recess
04 Pivoting wheel
05 —
06 Wheel
07 Motor/drive
08 Power electronics
09 Steering actuator
10 —
11 DC motor
12 Screw drive
13 Control unit

1. A vehicle drive unit for a vehicle for omnidirectional driving, the vehicle drive unit comprising:
a vehicle platform;
a drive platform;
at least two wheels arranged on the drive platform, each said wheel having a drive unit;
a controllable, self-locking steering actuator which is operatively arranged between the drive platform and the vehicle platform, the steering actuator being configured to cause a rotational movement of the vehicle platform relative to the drive platform when activated and also being configured for a temporary blocking of said rotational movement; and
at least three pivoting wheels arranged on the vehicle platform for vehicle stabilization, each of said pivoting wheels being rotatable about a wheel axis thereof and being pivotable about vertical axis thereof.

2. The vehicle drive unit according to claim 1, wherein the steering actuator comprises a screw drive and a motor.

3. The vehicle drive unit according to claim 2, wherein the screw drive is a ball screw drive, a planetary screw drive, a planetary roller screw drive, a roller screw drive, or a worm gear.

4. The vehicle drive unit according to claim 1, wherein the drive unit of each of the wheels is a differential drive.

5. The vehicle drive unit according to claim 1, wherein wheel axes of the wheels are oriented coaxially.

6. The vehicle drive unit according to claim 5, wherein the steering actuator is oriented perpendicular to the wheel axes, and the wheels are pivotable about a longitudinal axis of the steering actuator.

7. The vehicle drive unit according to claim 1, wherein the vehicle platform and the drive platform are arranged coaxially with respect to one another.

8. The vehicle drive unit according to claim 7, wherein the drive platform is arranged coaxially on an inside of the vehicle platform.

9. The vehicle drive unit according to claim 1, further comprising power electronics arranged on the drive platform.

10. A vehicle having the vehicle drive unit according to claim 1.

11. A vehicle drive unit for a vehicle for omnidirectional driving, the vehicle drive unit comprising:
a vehicle platform;
a drive platform;
at least two drive wheels arranged on the drive platform, each said drive wheel having a drive unit;
a controllable, self-locking steering actuator which is operatively arranged between the drive platform and the vehicle platform, the steering being configured to cause a rotational movement of the vehicle platform relative to the drive platform when activated and also being configured for a temporary blocking of said rotational movement; and
at least three stabilizing wheels arranged on the vehicle platform configured for vehicle stabilization.

12. The vehicle drive unit according to claim 11, wherein the steering actuator comprises a screw drive and a motor.

13. The vehicle drive unit according to claim 12, wherein the screw drive is a ball screw drive, a planetary screw drive, a planetary roller screw drive, a roller screw drive, or a worm gear.

14. The vehicle drive unit according to claim 11, wherein the drive unit of each of the drive wheels is a differential drive.

15. The vehicle drive unit according to claim 11, wherein wheel axes of the drive wheels are oriented coaxially.

16. The vehicle drive unit according to claim 15, wherein the steering actuator is oriented perpendicular to the wheel axes, and the drive wheels are pivotable about a longitudinal axis of the steering actuator.

17. The vehicle drive unit according to claim 11, wherein the vehicle platform and the drive platform are arranged to rotate about a common axis.

18. The vehicle drive unit according to claim 17, wherein the drive platform is arranged inside of the vehicle platform.

19. The vehicle drive unit according to claim 11, further comprising power arranged on the drive platform.
